(19) United States
(12) Patent Application Publication
(10) Pub. No.: US 2025/0358512 A1
(43) Pub. Date: Nov. 20, 2025

(54) IMAGE CAPTURING DEVICE, RECORDING MEDIUM, AND IMAGE CAPTURING METHOD

(71) Applicant: CANON KABUSHIKI KAISHA, Tokyo (JP)

(72) Inventor: Sohi KODAMA, Kanagawa (JP)

(21) Appl. No.: 19/098,261

(22) Filed: Apr. 2, 2025

(30) Foreign Application Priority Data
May 14, 2024 (JP) 2024-079020

(51) Int. Cl. H04N 23/67; H04N 23/61

(52) U.S. Cl. CPC H04N 23/675; H04N 23/61

(57) ABSTRACT

An image capturing device has an image capturing unit, an information acquisition unit that acquires photo shot information at the time of photo shooting by the image capturing unit, a defocus range estimation unit that estimates a defocus range with respect to one or more parts of an object on the basis of the photo shot information at the time of photo shooting, an importance level calculation unit that calculates an importance level of a photo shot image, in which the defocus range has been estimated, on the basis of the photo shot information at the time of photo shooting and the defocus range, and a saving unit that saves the importance level and the photo shot image in association with each other.

### CROSS-REFERENCE TO RELATED APPLICATION

This application claims the benefit of Japanese Patent Application No. 2024-79020, filed May 14 2024, which is hereby incorporated by reference wherein in its entirety.

### BACKGROUND

### Technical Field

The present invention relates to image processing.

### Description of the Related Art

In the related art, most digital cameras are equipped with an image display device such as liquid crystal display and are capable of displaying a preview or displaying a playback of image data saved in a recording medium. In addition, some digital cameras are equipped with a unit configured to set an importance level for a displayed image after photo shooting. Photo-shooters using such digital cameras may be able to save a large number of images in the recording medium so that they shoot a very large number of images and impart the importance level thereto.

Japanese Patent Laid-Open No. 2022-86521 discloses a technology of imparting an importance level to a photo shot image after photo shooting based on the focusing condition of the image used as a feature amount of the image.

However, in the method described in Japanese Patent Laid-Open No. 2022-86521, it is judged whether or not an image in its entirety is in focus, and it is not possible for a user to digitize a focus level of an intended local area. In this case, it is not possible for the user to impart an intended importance level to a photo shot image with fine granularity. In addition, in a method in which the importance level is imparted after photo shooting, there is a probability that a time lag will occur from the time of photo shooting so that it will not be able to be adapted for a scene in which a photo shot image is desired to be immediately used.

The present disclosure provides an image capturing device capable of automatically imparting a rating to a captured image at the time of photo shooting.

### SUMMARY

An image capturing device as an aspect of the present invention has an image capturing unit, an information acquisition unit that acquires photo shot information at the time of photo shooting by the image capturing unit, a defocus range estimation unit that estimates a defocus range with respect to one or more parts of an object on the basis of the photo shot information at the time of photo shooting, an importance level calculation unit that calculates an importance level of a photo shot image, in which the defocus range has been estimated, on the basis of the photo shot information at the time of photo shooting and the defocus range, and a saving unit that saves the importance level and the photo shot image in association with each other.

Further features of the present invention will become apparent from the following description of exemplary embodiments with reference to the attached drawings.

### BRIEF DESCRIPTION OF THE DRAWINGS

FIG. 1 is a view of a hardware configuration of an image capturing device according to an embodiment.

FIG. 2 is a view of an image capturing optical system for describing a defocus amount according to the embodiment.

FIG. 3 is a view of a constitution of the image capturing device according to the embodiment.

FIGS. 4A and 4B are view of a constitution of an information acquisition unit according to the embodiment.

FIG. 5A to 5D are view of a constitution of a defocus range inference unit according to Embodiments 1 and 3.

FIGS. 6A and 6B are explanatory view of a defocus range according to Embodiments 1 to 4.

FIG. 7 is a flowchart of processing executed by the image capturing device according to Embodiments 1 and 2.

FIGS. 8A and 8B are example of defocus range estimation values according to Embodiments 1 and 2.

FIG. 9 is a flowchart of processing executed by the image capturing device according to Embodiment 3.

FIG. 10 is an example of object detection results and spots input by a user according to Embodiment 3.

FIG. 11 is a flowchart of processing executed by the image capturing device according to Embodiment 4.

### DESCRIPTION OF THE EMBODIMENTS

Hereinafter, embodiments will be described in detail with reference to the accompanying drawings. The following embodiments do not limit the invention related to the claims. The embodiments describe a plurality of features, but all of the plurality of features are not essential to the invention, and the plurality of features may be arbitrarily combined. Moreover, in the accompanying drawings, the same reference numbers are applied to the same or similar constituents, and duplicate description will be omitted.

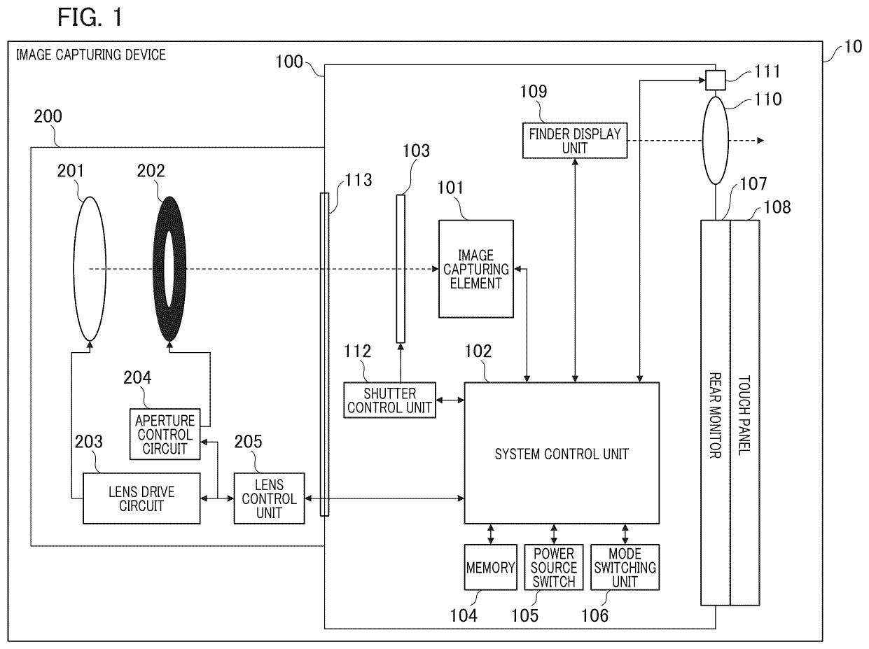

Prior to description of the embodiments according to the present invention, a hardware configuration in which an image capturing device 10 shown in each of the embodiments is mounted will be described with reference to FIG. 1. In the present embodiment, a case of shooting an image in focus on a plurality of objects will be described in consideration of extents of the objects in a depth direction in a lens interchangeable digital camera.

Hereinafter, preferred embodiments of the present invention will be described with reference to the drawings. FIG. 1 is an exemplary view of a hardware configuration of a main portion of the image capturing device (digital camera) 10. Hereinafter, the constitution of the image capturing device 10 of the present invention will be described with reference to FIG. 1. The image capturing device 10 is a lens interchangeable digital camera, for example, and is constituted of a camera main body 100 and a lens unit 200 guiding incident light to an image capturing element 101.

First, the camera main body 100 will be described. The image capturing element 101 is constituted of a CMOS-type imaging sensor and converts optical signals (optical image) into electric signals. Rays of light incident on a photo shooting lens 201 are subjected to image formation as an optical image on the image capturing element 101 through an aperture 202 and a shutter 103.

A system control unit 102 is constituted of at least one computer with a built-in CPU and the like and controls the camera main body 100 in its entirety. The system control unit 102 further includes an image processing unit (not shown) for video signals obtained by the image capturing element 101. In addition, the system control unit 102 further includes a phase difference AF unit performing focus detection processing by a phase difference detection method on the basis of image data for focus detection (signals for phase difference AF) obtained from the image capturing element 101 and the image processing unit. More specifically, the image processing unit generates, as the image data for focus detection, a pair of pieces of image data formed by light beams passing through a pair of pupil areas of an image capturing optical system. The phase difference AF unit (not shown) detects the amount of focal deviation on the basis of the amount of deviation between the pair of pieces of image data. In this manner, the phase difference AF unit of the present embodiment performs phase difference AF (image capturing surface phase difference AF) based on an output of the image capturing element 101 without using any dedicated AF sensor. The system control unit 102 may be constituted and function as an image processing device (information processing device). In this case, the image capturing device 10 internally includes the image processing device (information processing device). In addition, the image capturing device 10 may function as the image processing device.

A memory 104 stores programs, variables, constants, and the like for operating the system control unit 102. In addition, this memory 104 also includes an electrically erasable/storable non-volatile memory and stores setting values such as various parameters and an ISO sensitivity, photo shooting modes, various kinds of correction data, and the like. A power source switch 105 switches between ON and OFF modes of a power source of the camera main body 100. A mode switching unit 106 is a switch for switching and setting various photo shooting modes such as live view shooting and moving image shooting.

A rear monitor (display unit) 107 is constituted of a liquid crystal device, an LED, and the like displaying photo shot information such as operation states of characters, images, audio, and the like, and messages in response to execution of a program in the system control unit 102. A touch panel 108 is disposed in substantially the same area as the rear monitor 107, thereby detecting contact with a finger or a pen, for example, notifying the system control unit 102 of a contact position in the rear monitor 107, and executing an operation or a function associated with the contact position.

Similar to the rear monitor 107, a finder display unit 109 is a display unit displaying photo shot information in response to execution of a program in the system control unit 102 and constitutes an electronic viewfinder (EVF) together with an eyepiece lens 110. In addition, the reference number 111 indicates an eyepiece detection unit, and the system control unit 102 causes the rear monitor 107 or the finder display unit 109 to selectively display the foregoing photo shot information in response to the eyepiece state of a photo shooter. A shutter control unit 112 controls operation of the shutter 103 on the basis of results of photometry of an object computed by the system control unit 102. The shutter 103 can be controlled in conjunction with the aperture 202.

Next, a constitution of the lens unit 200 will be described. The camera main body 100 and the lens unit 200 are connected mechanically and electrically via a lens mounting mechanism (mounting unit) 113. Moreover, the camera main body 100 and the lens unit 200 can be attached and detached via the lens mounting mechanism 113. The lens unit 200 is constituted of the photo shooting lens 201, the aperture 202, a lens drive circuit 203, an aperture control circuit 204, and a lens control unit 205. FIG. 1 simply shows one photo shooting lens 201 for the sake of simplicity but is actually constituted of a group of many photo shooting lenses.

The lens control unit 205 is constituted of at least one computer having a CPU, a memory, and the like and controls the lens unit 200 in its entirety. For example, the memory (not shown) provided in the lens control unit 205 stores various constants, variables, programs, and the like for operating the lenses. In addition, the lens control unit 205 also includes a non-volatile memory (not shown) retaining information unique to the lens unit, such as maximum and minimum aperture values, a focal distance, and the like.

The system control unit 102 of the camera main body 100 computes a defocus amount using output information of the image capturing element 101. Further, the system control unit 102 performs communication via the lens control unit 205 of the lens unit 200 on the basis of the computed defocus amount and adjusts the focus by controlling the lens drive circuit 203.

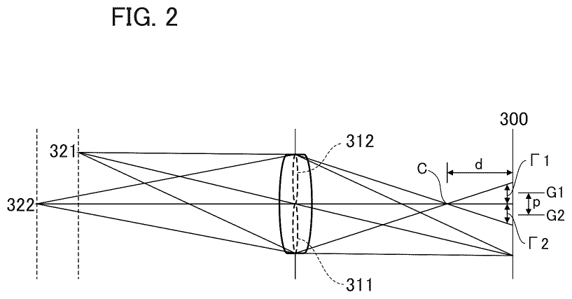

Here, the foregoing defocus amount will be described with reference to FIG. 2. FIG. 2 is an explanatory view of a relationship between the defocus amount of the image capturing optical system and the phase difference (image deviation amount) between a first focus detection signal and a second focus detection signal acquired from the image capturing element.

In FIG. 2, an image capturing element (not shown) is disposed on an image capturing surface 300, and an exit pupil of the image capturing optical system is bisected into a first pupil area 311 and a second pupil area 312. A defocus amount d is defined, while the distance (magnitude) from an image formation position C of light beams from an object 321 and an object 322 to the image capturing surface 300 is |d|, such that a front focus state in which the image formation position C is on the object side from the image capturing surface 300 is expressed with the negative sign (d<0). Moreover, it is defined such that a rear focus state in which the image formation position C is on a side opposite to the object from the image capturing surface 300 is expressed with the positive sign (d>0). In a focus state in which the image formation position C is on the image capturing surface 300, d=0 is established. The image capturing optical system is in the focus state (d=0) with respect to the object 321 and is in the front focus state (d<0) with respect to the object 322. The front focus state (d<0) and the rear focus state (d>0) are collectively referred to as the defocus state (|d|>0).

In the front focus state (d<0), the light beams, of the light beams from the object 322, which have passed through the first pupil area 311 (second pupil area 312) are temporarily condensed and then extend to a width Γ1 (Γ2) centered on a gravity center position G1 (G2) of the light beams, thereby forming a blurred image on the image capturing surface 300. This blurred image is received by each of first focus detection pixels (each of second focus detection pixels) on the image capturing element, and the first focus detection signal (second focus detection signal) is generated. Namely, the first focus detection signal (second focus detection signal) becomes a signal for expressing an object image in which the object 322 is blurred by the width Γ1 (Γ2) at the gravity center position G1 (G2) of the light beams on the image capturing surface 300.

The width Γ1 (Γ2) which is a blur width of an object image increases substantially in proportion to increase in the magnitude |d| of the defocus amount d. Similarly, a magnitude |p| of an image deviation amount p between the first focus detection signal and the second focus detection signal (=difference between gravity center positions of the light beams G1−G2) also increases substantially in proportion to increase in the magnitude |d| of the defocus amount d. Although the direction of image deviation between the first focus detection signal and the second focus detection signal becomes opposite to that in the front focus state, the same applies to the rear focus state (d>0) as well.

In this manner, the magnitude of the image deviation amount between the first and second focus detection signals increases in response to increase in the magnitude of the defocus amount. In the present embodiment, focus detection is performed by an image capturing surface phase difference detection method for calculating the defocus amount from the image deviation amount between the first and second focus detection signals obtained using the image capturing element 101. Therefore, the phase difference AF unit of the system control unit 102 converts the image deviation amount into a detected defocus amount in response to increase in the magnitude of the defocus amount of an image capturing signal. Specifically, based on the relationship in which the magnitude of the image deviation amount between the first focus detection signal and the second focus detection signal increases, the image deviation amount is converted into the detected defocus amount using a conversion coefficient calculated on the basis of a baseline length. According to the present embodiment, the product [Fδ] of an aperture F value in the optical system of the image capturing device at the time of image shooting and an allowable diameter δ of a confusion circle is used as the unit of the defocus amount.

In the present embodiment, a method for imparting an importance level to a photo shot image will be described on the basis of “a part to be used as a criterion for a focus level when an importance level is imparted to a photo shot image” selected by a user during photo shooting. In the present embodiment, description will be given with an example in which a user has selected a mode of person's right eye (Namely, it is desired to impart the importance level depending on how well the right eye is in focus). However, the foregoing mode is an example and does not limit the present invention. Furthermore, for example, categories can include person, animal, vehicle, and the like. Moreover, in addition to the right eye, for example, there are parts, such as the left eye, the face, the body, the foot, the ankle, the hand, and the wrist as parts of a human body, and a mode in which these are combined (combination mode) may be able to be selected.

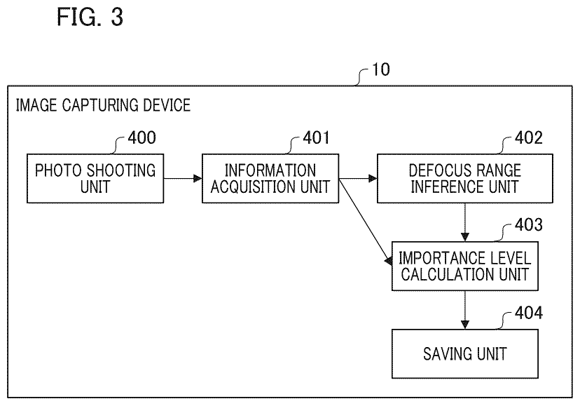

FIG. 3 is a block diagram showing an example of functions of the image capturing device 10 according to Embodiment 1. The image capturing device 10 according to the present embodiment has, as its functional units, a photo shooting unit 400, an information acquisition unit 401, a defocus range inference unit 402, an importance level calculation unit 403, and a saving unit 404. Operation (processing) in each of these functional units is controlled by the system control unit 102.

The photo shooting unit 400 shoots still images and video images. During photo shooting, the photo shooting unit 400 receives an input of a predetermined mode from a live view screen or a dial (not shown) provided in the image capturing device 10.

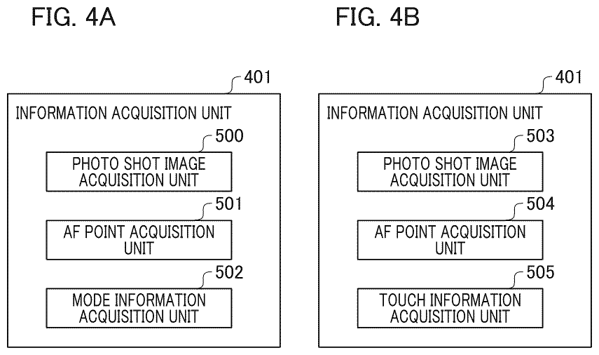

The information acquisition unit 401 acquires information at the time of photo shooting (photo shot information) by the photo shooting unit 400. FIG. 4 is a view of a constitution of the information acquisition unit according to Embodiment 1 and Embodiment 3. FIG. 4A is a block diagram of a constitution of the information acquisition unit 401 according to Embodiments 1 and 2. FIG. 4B is a block diagram of a constitution of the information acquisition unit 401 according to Embodiments 3 and 4. The functional units and the like in FIG. 4B will be described below.

The information acquisition unit 401 of Embodiment 1 has, as the functional units, a photo shot image acquisition unit 500, an AF point acquisition unit 501, and a mode information acquisition unit 502. The photo shot image acquisition unit 500 acquires photo shot images and video images using the photo shooting unit 400. In the case of video images, they are acquired in a manner of being divided into frames, and processing is performed one by one in the same manner as that in images. In the present embodiment, description will be given on the assumption that an image has been acquired. The AF point acquisition unit 501 acquires a focal point in the depth direction (which will hereinafter be denoted as an AF point) during photo shooting by the photo shooting unit 400. The mode information acquisition unit 502 acquires mode information, which is information on a mode for a part to be used as a criterion for the focus level when the importance level of an object is imparted, set by the photo shooting unit 400 during photo shooting. In other words, the mode information acquisition unit 502 acquires mode information which is information on a mode for setting a photo shooting subject of interest in a photo shot image selected during photo shooting.

The information acquisition unit 401 outputs the photo shot image and the mode information, which are acquired photo shot information, to the defocus range inference unit 402. Moreover, the information acquisition unit 401 outputs the mode information and the AF point (focal position), which are acquired photo shot information, to the importance level calculation unit 403. That is, the photo shot information according to the present embodiment includes information on a photo shot image, the mode information, and information on the AF point.

The defocus range inference unit (estimation unit) 402 identifies a part of an object for which the defocus range is to be inferred (estimated) on the basis of the photo shot information output from the information acquisition unit 401 and infers the defocus range of the identified part. The defocus range is a value range of the defocus amount in a part of an object. Parameters of the defocus range are values of the defocus amounts at two end points of the range (closest defocus amount and farthest defocus amount).

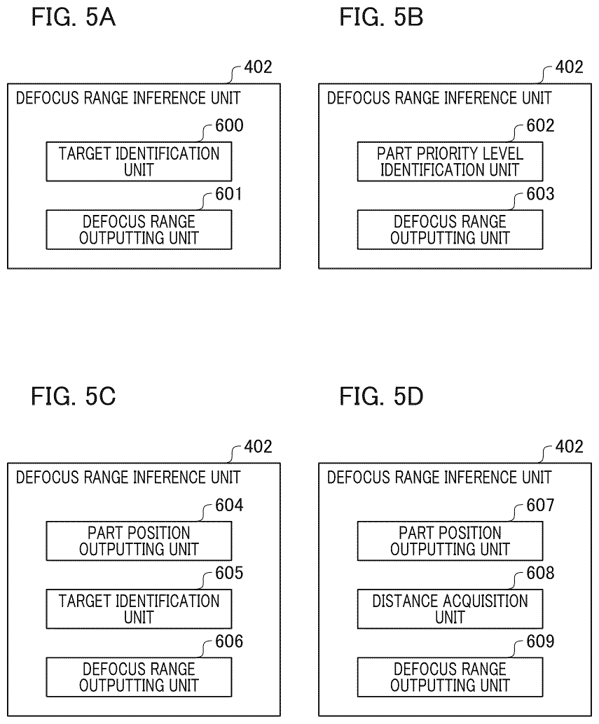

FIG. 5 is a view of a constitution of the defocus range inference unit according to Embodiments 1 to 4. FIG. 5A is a block diagram of a constitution in the defocus range inference unit 402 according to Embodiment 1. FIG. 5B is a block diagram of a constitution in the defocus range inference unit 402 according to Embodiment 2. FIG. 5C is a block diagram of a constitution in the defocus range inference unit 402 according to Embodiment 3. FIG. 5D is a block diagram of a constitution in the defocus range inference unit 402 according to Embodiment 4. The functional units and the like in FIGS. 5B to 5D will be described below.

The defocus range inference unit 402 is constituted of a target identification unit 600 and a defocus range outputting unit 601. The target identification unit 600 identifies a part of an object for which the defocus range is to be inferred (which will hereinafter be denoted as a target part) from the information on the mode acquired by the mode information acquisition unit 502. The defocus range outputting unit 601 infers the defocus range of the part of the object identified by the target identification unit 600 with respect to a photo shot image. The defocus range inference unit 402 outputs the inferred defocus range, the mode information, and the photo shot image to the importance level calculation unit 403.

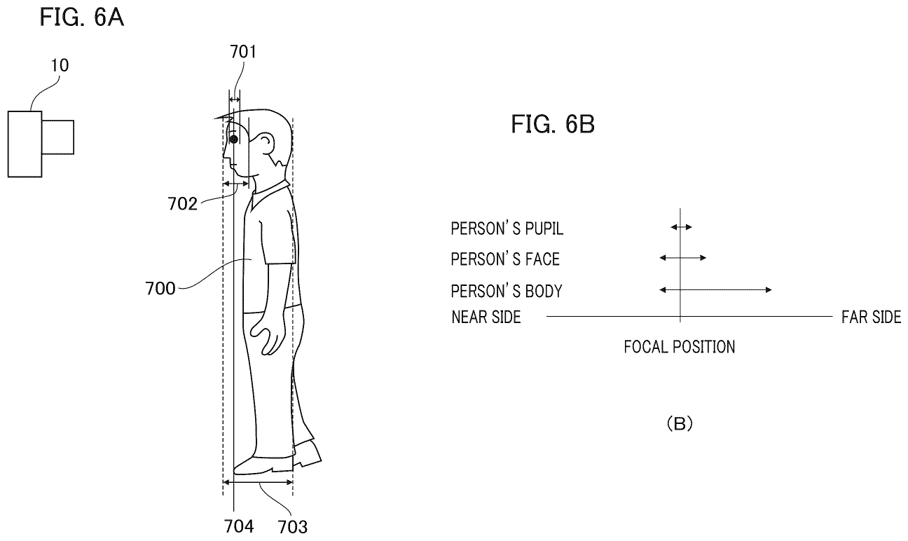

FIG. 6 is an explanatory view of a defocus range. FIG. 6A shows a situation in which photo shooting of a person 700 is performed using the image capturing device 10. In addition, the reference number 701 denotes the person's pupil, the reference number 702 denotes the person's face, and the reference number 703 denotes the person's body, of which the extents (presence ranges) are individually visualized in the depth direction as objects viewed from the image capturing device 10. The reference number 704 denotes that the focal position in the image capturing device 10 is the position of the person's pupil 701. In addition, FIG. 6B expresses a schematic view of estimated defocus ranges of the person's pupil 701, the person's face 702, and the person's body 703. In the horizontal axis direction, the degrees of deviation from the focal position are indicated as the defocus amounts while having the focal position (focal plane) as a criterion. That is, the magnitude (absolute value) of the defocus amount increases as the distance from the focal position increases. A side closer to the image capturing device 10 is defined as a near side, and a side farther from it is defined as a far side. The lengths of line segments indicate ranges where the respective parts of the object (person) are present (in FIG. 6B, the person's pupil, the person's face, and the person's body) and show a distribution the defocus amounts of the object parts corresponding to the ranges.

In FIG. 6A, for example, regarding the extent (presence range) of the person's body 703 as an object in the depth direction viewed from the camera, the nearest side is the person's nose tip, for example, and the farthest side is the person's shoulder tip, for example. For this reason, the maximum value (nearest value) of the defocus amount of the person's body 703 is the defocus amount indicating the person's nose tip, and the minimum value (farthest value) of the defocus amount is the defocus amount indicating the person's shoulder tip. The value range stipulated by these values is the defocus range of the person's body 703. The person's body in FIG. 6B expresses the relationship therebetween. The farthest value is 1.4Fδ, for example, and the nearest value is −0.2Fδ, for example. The farthest value and the nearest value are acquired for each part of the object as the parameters indicating the defocus range.

In this manner, the defocus range outputting unit 601 estimates the defocus range, which is the value range of the defocus amount, taking into account perspective relationships of estimation subjects such as the pupil, the face, and the body of the person in the depth direction. In the present embodiment, the defocus range outputting unit 601 takes a photo shot image and a defocus map as inputs, and outputs the defocus range of the object. A defocus map is information on a distribution of the defocus amounts in which defocus amounts are assigned to a certain number of pixels on the image capturing surface. As estimation results, the defocus range outputting unit 601 distinguishes the object and individually outputs a defocus range for the object in its entirety or each part such as the pupil, the face, and the body.

The defocus range outputting unit 601 can gain learning data as an input by machine learning. Specific examples of machine learning algorithm include deep learning in which feature amounts for learning and combined weighting coefficients are self-generated utilizing a neural network. Here, learning using a neural network will be described. Learning is performed using learning data including learning images, defocus maps, and correct defocus ranges as input data. In learning, error detection processing and weight updating processing are performed. In the error detection processing, an error between the output data, which is output from an output layer of the neural network in response to the input data input to an input layer, and teacher data is obtained. At this time, a correct defocus range is used as the teacher data. In the error detection processing, an error between the output data from the neural network and the teacher data may be calculated using a loss function.

In the weight updating processing, the combined weighting coefficients and the like between nodes in the neural network are updated on the basis of the error obtained in the error detection processing such that the error is reduced. For example, in this weight updating processing, the combined weighting coefficients and the like are updated using an error back-propagation method. The error back-propagation method is a technique of adjusting the combined weighting coefficients and the like between the nodes in each neural network such that the foregoing error is reduced.

The output data output as a result of learning is a machine learning model for estimating a defocus range. A defocus range is estimated using the machine learning model which has been learned by the learning method described above.

The importance level calculation unit 403 calculates the importance level of a photo shot image on the basis of the defocus range output from the defocus range inference unit 402 and the positional relationship of the AF point output from the information acquisition unit 401. The importance level calculation unit 403 outputs the calculated importance level and the photo shot image to the saving unit 404.

The saving unit 404 associates the importance level calculated by the importance level calculation unit 403 and the photo shot image with each other and saves them in a storage medium such as an external storage device. Examples of the external storage device include an SD card, a flexible disk (FD), a CD-ROM, a DVD, a USB memory, and an MO. In addition, it may be a server device or the like connected through a network.

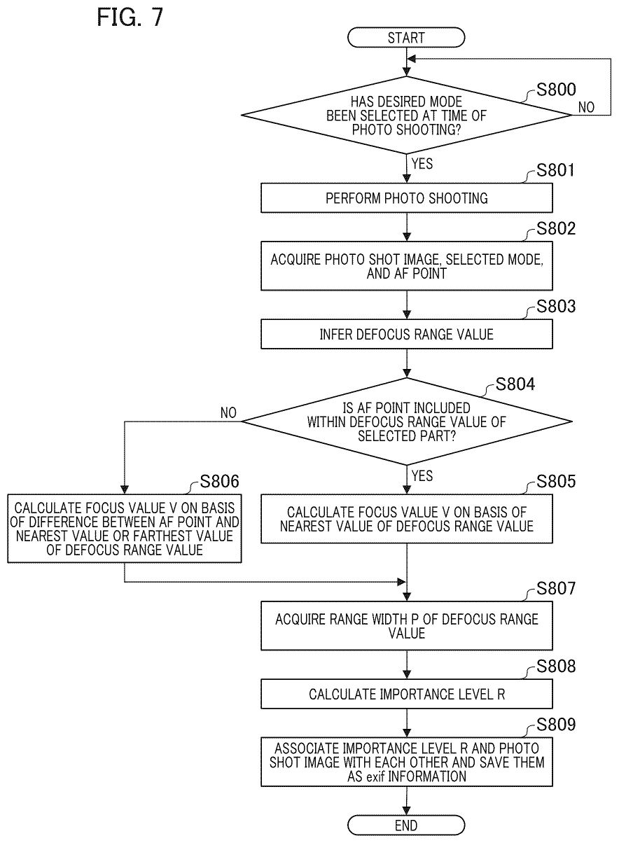

Next, a procedure of processing performed by the image capturing device 10 according to the present embodiment will be described with reference to FIG. 7. FIG. 7 is a flowchart of processing executed by the image capturing device 10 according to Embodiment 1. Each process of operation (processing) shown in the flowchart of FIG. 7 is realized by the system control unit 102 executing a program stored in the memory 104 or the like. In addition, in the following description, each process (step) will be denoted by adding “S” to the beginning, and notation of the process (step) will be omitted.

In S800, the photo shooting unit 400 judges whether a desired mode has been selected by a user at the time of photo shooting. That is, it is judged whether a mode has been selected for a part of an object to be used as a criterion when imparting an importance level of an image shot by a user at the time of photo shooting. If a mode has been selected for the part of the object, the processing proceeds to S801. Meanwhile, if a mode has not been selected for the part of the object, the processing stands by until a mode is selected for the part. In the present embodiment, it is assumed that a mode designating “person's right eye” (right eye mode) has been selected.

In S801, the photo shooting unit 400 shoots an image. For example, the photo shooting unit 400 shoots an image in response to a user input. In S801, an image is shot in the mode selected in S800 (mode of “person's right eye”).

In S802, the information acquisition unit 401 acquires the photo shot information which is information at the time of photo shooting in S801. Specifically, the photo shot image acquisition unit 500 provided in the information acquisition unit 401 acquires an image (photo shot image) or a video image shot by the photo shooting unit 400. Moreover, the AF point acquisition unit 501 provided in the information acquisition unit 401 acquires an AF point. Moreover, the mode information acquisition unit 502 provided in the information acquisition unit 401 acquires information as the mode information indicating that the image has been shot in the right eye mode. The information acquisition unit 401 outputs the acquired photo shot image and mode information to the defocus range inference unit 402. Moreover, the information acquisition unit 401 outputs the acquired mode information and information on the AF point to the importance level calculation unit 403. In this manner, the information acquisition unit 401 acquires the photo shot image (or the video image), the AF point, and the mode information as the photo shot information.

In S803, the defocus range inference unit 402 infers (estimates) and outputs the defocus range. During this processing, in the defocus range inference unit 402, first, the target identification unit 600 identifies a target part from the mode information output in S802. In the case of the present embodiment, it is identified as “person's right eye”. Next, the defocus range outputting unit 601 infers the defocus range of the part of the object identified by the target identification unit 600 with respect to the photo shot image output in S802. In the case of this processing, the defocus range outputting unit 601 infers the defocus range of “person's right eye” in the photo shot image. The defocus range inference unit 402 outputs the inferred defocus range, the mode information, and the photo shot image to the importance level calculation unit 403.

In S804, the defocus range inference unit 402 judges whether or not the AF point is included within the defocus range output in S803. The AF point is a focal position (focal plane) when the image capturing device performs autofocus control. If the AF point is included within the defocus range, the processing proceeds to S805. Meanwhile, if the AF point is not included within the defocus range, the processing proceeds to S806.

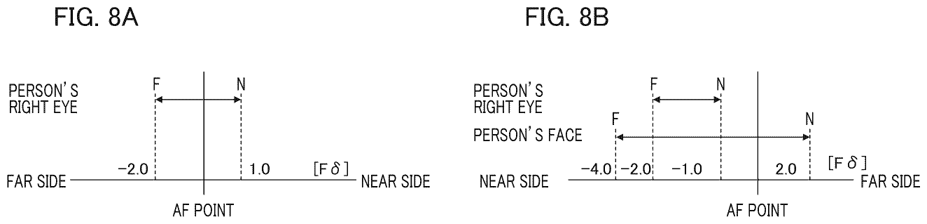

FIG. 8 is an example of defocus range estimation values according to Embodiments 1 and 2. FIG. 8A shows an output example of a defocus range according to the present embodiment. FIG. 8B is a view showing an output example of a defocus range according to Embodiment 2. FIG. 8B will be described below.

In FIG. 8A, it is assumed that the defocus range of “person's right eye” is “−2.0Fδ to 1.0Fδ” and the AF point is included in the defocus range.

In S805, the importance level calculation unit 403 calculates a focus value V on the basis of the AF point and the nearest value of the defocus range. For example, calculation of the focus value Vis performed as in the following Expression (1), but it is not limited thereto.

$$[ Expression 1 ]$$

$$V = 100 + {P}_{max} / ( N + 1 e - 5 ) \qquad ( 1 )$$

In the foregoing Expression (1), Pₘₐₓ indicates a maximum width of the defocus range of the part of the object (which will hereinafter be denoted as a maximum width Pₘₐₓ), and N indicates the nearest value of the defocus range (which will hereinafter be denoted as a nearest value N). The maximum width Pₘₐₓ is the largest range width of the defocus range which can be output for each part in the categories of the object and needs to be set in advance. Since the value of the maximum width Pₘₐₓ to be set depends on a general thickness of each part, Pₘₐₓ of the face is set to be larger than Pₘₐₓ of the right eye, for example. In addition, when the AF point is closer to the nearest value N, it is judged that the part of the object is in focus more minutely, and the focus value Vis calculated to be higher. In the present embodiment, it is assumed that Pₘₐₓ=5.0 is set for the maximum width Pₘₐₓ of the person's right eye. In this case, the focus value Vis calculated as V≈105.

In S806, the importance level calculation unit 403 calculates the focus value V on the basis of the difference between the AF point and the nearest value or the farthest value of the defocus range. For example, calculation of the focus value V is performed as in the following Expression (2), but it is not limited thereto.

$$[ Expression 2 ]$$

$$\begin{matrix}V = 10 \; 0 - F & N > 0\end{matrix} \qquad ( 2 )$$

$$V = 100 - \vert N \vert \qquad N < 0$$

In the foregoing Expression (2), F indicates the farthest value of the defocus range (which will hereinafter be denoted as a farthest value F). In addition, the expression branches depending on whether the nearest value N is larger or smaller than zero. When the AF point is closer to the nearest value N or the farthest value F, it is judged that the level of blurring (out of focus) in the part of the object is low, and the focus value V is calculated to be higher.

In S807, the importance level calculation unit 403 calculates the range width P of the defocus range on the basis of the difference with respect to the nearest value and the farthest value. For example, calculation of the range width P is performed as in the following Expression (3).

$$[ Expression 3 ]$$

$$P = \vert N - F \vert \qquad ( 3 )$$

As shown in the foregoing Expression (3), when P becomes smaller, the part of the object is in focus with better pinpoint accuracy. In the case of the present embodiment, P=3.0 is set for the range width P.

In S808, the importance level calculation unit 403 calculates an importance level R on the basis of the focus value V calculated in S805 or S806 and the range width P calculated in S807. Thereafter, the importance level calculation unit 403 outputs the calculated importance level R and the photo shot image to the saving unit 404. For example, calculation of the importance level R according to the present embodiment is performed as in the following Expression (4), but it is not limited thereto.

$$[ Expression 4 ]$$

$$R = V / P \qquad ( 4 )$$

When the AF point is closer to the nearest value of the defocus range, the position closer to the surface of the part in the depth direction intended by a user is in focus, and the importance level R rises. In addition, when the defocus range is narrower, it is in focus with better pinpoint accuracy, and the importance level R is calculated to be higher. In the case of the present embodiment, the importance level R is calculated as R≈35.

In S809, the saving unit 404 associates the photo shot image in which the defocus range has been inferred and the importance level R calculated in S808 with each other and saves them in a storage medium such as an external storage device as exchangeable image file format (Exif) information.

Hereinabove, according to the image capturing device 10 of Embodiment 1, the importance level of a photo shot image can be automatically imparted at the time of photo shooting depending on the focus level of the part of an object used as the criterion set by a user. In other words, a rating can be automatically imparted to a photo shot image simultaneously with photo shooting by correctly inferring the focus level of a local area in each photo shot image intended by a user on the basis of the area selected by the user at the time of photo shooting and the inference results of the defocus range.

### Embodiment 2

In each of the following embodiments (Embodiments 3 and 4) including Embodiment 2, points different from Embodiment 1 will be described, and unless otherwise stated below, it will be assumed that they are similar to Embodiment 1. Therefore, description of points and constitutions similar to those in Embodiment 1 will be omitted.

In the present embodiment, a method for imparting an importance level to a photo shot image will be described on the basis of “a priority level of a part to be used as a criterion for the focus level when an importance level is imparted to a photo shot image” selected by a user during photo shooting. In the present embodiment, description will be given with an example in which a user has selected a mode in which “person's right eye” is given first priority and “person's face” is given second priority. Namely, it is assumed that the mode has been selected with the intention of imparting an importance level to whether the right eye is in focus first, and whether the face is in focus second. However, the mode is merely an example and does not limit the present invention. In addition, within a range of parts for which defocus inference is possible, the number of priority levels to be set can also be changed.

The defocus range inference unit (estimation unit) 402 identifies all parts of an object for which the defocus range is to be inferred on the basis of the photo shot information output from the information acquisition unit 401 and infers the defocus range of each of all the identified parts. As shown in FIG. 5B, the defocus range inference unit 402 according to Embodiment 2 has a part priority level identification unit 602 and a defocus range outputting unit 603.

The part priority level identification unit 602 identifies a target part from the mode information acquired by the mode information acquisition unit 502. That is, the part priority level identification unit 602 identifies a plurality of parts of an object for which the defocus range is output and the priority level for each part from the mode information acquired by the mode information acquisition unit 502. Further, the target parts identified by the part priority level identification unit 602 correspond to all parts for which the priority levels have been set.

The defocus range outputting unit 603 individually infers the defocus range of each target part identified by the part priority level identification unit 602 with respect to the photo shot image. That is, the defocus range outputting unit 603 estimates the defocus range for each part for which the priority level has been set. The defocus range inference unit 402 outputs the inferred defocus range, the mode information, and the photo shot image to the importance level calculation unit 403.

The importance level calculation unit 403 calculates the importance level of a photo shot image on the basis of the inferred defocus range, the positional relationship of the AF point, and the priority level of the part within the mode information. The importance level calculation unit 403 outputs the calculated importance level and the photo shot image to the saving unit 404.

Next, a procedure of processing performed by the image capturing device 10 according to the present embodiment will be described with reference to FIG. 7. Each process of operation (processing) shown in the flowchart of FIG. 7 is realized by the system control unit 102 executing a program stored in the memory 104 or the like. In addition, in the following description, each process (step) will be denoted by adding “S” to the beginning, and notation of the process (step) will be omitted.

S801 and S802 according to Embodiment 2 are similar to the processing of S801 and S802 according to Embodiment 1, and therefore description thereof will be omitted. In addition, S804 to S807 according to Embodiment 2 are similar to the processing of S804 to S807 according to Embodiment 1, and therefore description thereof will be omitted. In addition, S809 according to Embodiment 2 is similar to the processing of S809 according to Embodiment 1, and therefore description thereof will be omitted.

In S800, the photo shooting unit 400 judges whether a desired mode has been selected by a user at the time of photo shooting. That is, it is judged whether a priority level mode has been set (designated) for a part of an object to be used as a criterion for the focus level when imparting an importance level of an image shot by a user at the time of photo shooting. If a priority level mode has been set for the part of the object, the processing proceeds to S801. Meanwhile, if no priority level mode has been set for the part of the object, the processing stands by until a priority level mode is set. In the present embodiment, it is assumed that a priority level mode designating person's right eye” as the first priority and designating “person's face” as the second priority has been set.

In S803, the defocus range inference unit 402 infers (estimates) and outputs the defocus range. During this processing, in the defocus range inference unit 402, first, the part priority level identification unit 602 identifies all target parts from the mode information output in S802. In the case of the present embodiment, it is identified as “person's right eye” and “person's face”. Next, the defocus range outputting unit 603 infers the defocus range of the target part of the object identified by the target identification unit 600 with respect to the photo shot image output in S802. In the case of this processing, the defocus range outputting unit 601 individually infers the defocus range of “person's right eye” and “person's face” in the photo shot image. The defocus range inference unit 402 outputs the inferred defocus range, the mode information, and the photo shot image to the importance level calculation unit 403.

As shown in FIG. 8B, since the AF point is not included within the defocus range of “person's right eye”, the focus value V_{riht_eye}=99 is established by the foregoing Expression (2), and the range width P_{riht_eye}=3.0 is established by the foregoing Expression (3). Since the AF point is included within the defocus range of “person's face”, when the maximum width P_{max_face}=40 is established according to Expression 1, the focus value V_{face}≈120 is established, and the range width P_{face}=6.0 is established by the foregoing Expression (3).

In S808, the importance level calculation unit 403 calculates the importance level R on the basis of the focus value V of each part calculated in S805 or S806, the range width P calculated S807, and the priority level of the part (priority level of each part) in the mode information. The importance level calculation unit 403 outputs the calculated importance level R and the photo shot image to the saving unit 404. For example, calculation of the importance level R according to Embodiment 2 is performed as in the following Expression (5), but it is not limited thereto.

$$[ Expression 5 ]$$

$$R = {W}_{1} \times \frac{{V}_{parts \_ 1}}{{P}_{parts \_ 1}} + {W}_{2} \times \frac{{V}_{parts \_ 2}}{{P}_{parts \_ 2}} \qquad ( 5 )$$

$${W}_{1} \geq {W}_{2}$$

In the case of Embodiment 2, Parts_1=right_eye and Parts_2=face are set. In addition, W indicates a weight which is set in advance for each priority level, and the weight is varied according to the order of the priority level. In the present embodiment, when W₁=1.0 and W₂=0.5 are set, the importance level R is calculated as R≈43.

Hereinabove, according to the image capturing device 10 of Embodiment 2, the priority level can be set for a part of an object to be used as a criterion for the focus level set by a user, and the importance level of a photo shot image can be automatically imparted at the time of photo shooting while considering the focus level in consideration of the priority level.

### Embodiment 3

In Embodiment 3, when a user performs photo shooting, “a position to be used as a criterion for the focus level when an importance level is imparted to a photo shot image” of the live view screen is input during photo shooting. Further, a method for imparting an importance level of a photo shot image will be described on the basis of the focus level of a part of an object closest to the input position and the distance.

The information acquisition unit 401 acquires information at the time of photo shooting (photo shot information) by the photo shooting unit 400. As shown in FIG. 4B, the information acquisition unit 401 of Embodiment 3 has a photo shot image acquisition unit 503, an AF point acquisition unit 504, and a touch information acquisition unit 505. The photo shot image acquisition unit 503 and the AF point acquisition unit 504 perform processing similar to those of the photo shot image acquisition unit 500 and the AF point acquisition unit 501 of Embodiment 1, and therefore description thereof will be omitted.

The touch information acquisition unit 505 acquires information on a position to be used as a criterion for the focus level (which will hereinafter be an denoted as input spot) when imparting an importance level in a photo shot image input to the live view screen during photo shooting by the photo shooting unit 400 (acquisition of touch position information). The touch information acquisition unit 505 outputs the photo shot image and the input spot, which are acquired photo shot information, to the defocus range inference unit 402. Moreover, the touch information acquisition unit 505 outputs the AF point, which is acquired photo shot information, to the importance level calculation unit 403. An input may be made by any means, such as touching, eye-gaze inputting, audio inputting, and the like by a user and are not limited to these examples. In Embodiment 3, it is assumed that an input is made by touch.

The defocus range inference unit 402 identifies a target part from the position of the input spot and infers (estimates) the defocus range of the identified part on the basis of the photo shot information output from the information acquisition unit 401. As shown in FIG. 5C, the defocus range inference unit 402 according to Embodiment 3 has a part position outputting unit 604, a target identification unit 605, and a defocus range outputting unit 606.

The part position outputting unit 604 performs object detection inference with respect to the photo shot image output from the information acquisition unit 401 and outputs all positions of the parts which can be inferred. An object detection model retained in the part position outputting unit 604 is constituted of DNN and has been sufficiently subjected to learning of the position of a part of an object. Categories of objects include person, animal, and vehicle, and categories of parts include pupil, body, face, and the like, but they are not limited thereto. In addition, they need to be the same as the categories and the parts which can be output by the defocus range outputting unit 606. Output results of object detection include center positions of respective parts of objects which can be inferred, and kinds (labels) of the category and the part. In Embodiment 3, it is assumed that the center positions of a plurality of parts in an object which can be output are estimated (estimation of part position).

The target identification unit 605 identifies a target part by comparing the input spot within the photo shot image (input position in the live view screen) output from the information acquisition unit 401 and the output results of object detection (center positions of a plurality of parts) performed by the part position outputting unit 604. Specifically, a distance between the input spot within a photo shot image and the center position of each of all the inferred parts in a two-dimensional plane (distance information) is individually calculated, and a part of the object at a closest distance from the input position (proximity part) is identified as the target part. In other words, the target identification unit 605 identifies a part closest to the input position in the live view screen on the basis of the distance information on each of the input position in the live view screen and the center positions of a plurality of parts, and sets the part as a target portion. Examples of a distance calculation method include an Euclidean distance in a plane, but it is not limited thereto.

The defocus range outputting unit 606 infers the defocus range of the target part (proximity part) identified by the target identification unit 605 with respect to the photo shot image output from the information acquisition unit 401. The defocus range inference unit 402 outputs the inferred defocus range to the importance level calculation unit 403.

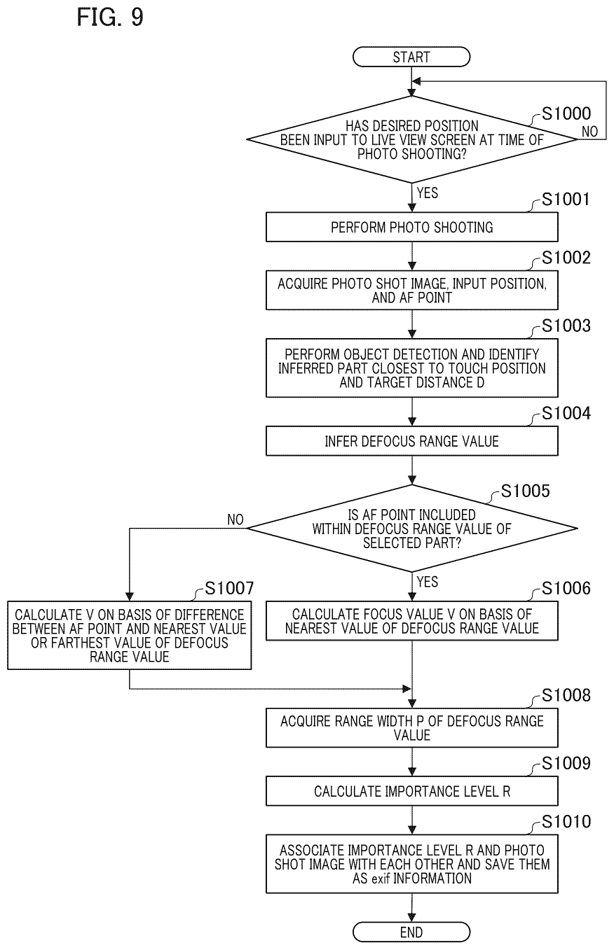

Next, a procedure of processing performed by the image capturing device 10 according to Embodiment 3 will be described with reference to FIG. 9. FIG. 9 is a flowchart of processing executed by the image capturing device 10 according to Embodiment 3. Each process of operation (processing) shown in the flowchart of FIG. 9 is realized by the system control unit 102 executing a program stored in the memory 104 or the like. In addition, in the following description, each process (step) will be denoted by adding “S” to the beginning, and notation of the process (step) will be omitted.

S1005 to S1008 according to Embodiment 3 are similar to the processing of S804 to S807 in Embodiment 1, and therefore description thereof will be omitted. In addition, S1010 according to Embodiment 3 is similar to the processing of S809 in Embodiment 1, and therefore description thereof will be omitted.

In S1000, the photo shooting unit 400 judges whether a desired position has been input to the live view screen by a user at the time of photo shooting. That is, it is judged whether “a position to be used as a criterion for the focus level when an importance level is imparted to a photo shot image” has been input by a user at the time of photo shooting. If the desired position of the live view screen is input, the processing proceeds to S1001. Meanwhile, if a desired position has not been input to the live view screen, the processing stands by until the desired position is input. In the present embodiment, a position to be used as a criterion for the focus level when an importance level is imparted to a photo shot image is input by touch.

In S1001, the photo shooting unit 400 shoots an image. For example, the photo shooting unit 400 shoots an image in response to a user input.

In S1002, the information acquisition unit 401 acquires the photo shot information which is information at the time of photo shooting in S1001. Specifically, the photo shot image acquisition unit 503 provided in the information acquisition unit 401 acquires an image (photo shot image) or a video image shot by the photo shooting unit 400. Moreover, the AF point acquisition unit 504 provided in the information acquisition unit 401 acquires an AF point. Moreover, the touch information acquisition unit 505 provided in the information acquisition unit 401 acquires information on the input spot input by touch in S1000. The information acquisition unit 401 outputs the acquired photo shot image and information on the input spot to the defocus range inference unit 402. Moreover, the information acquisition unit 401 outputs the acquired information on the AF point to the importance level calculation unit 403. In this manner, the information acquisition unit 401 acquires the photo shot image (or the video image), the AF point, and the information on the input spot as the photo shot information.

In S1003, the defocus range inference unit 402 identifies a part of an object for which the defocus range is to be inferred (estimated) from the input position in the live view screen and infers and outputs the defocus range of the identified part. During this processing, in the defocus range inference unit 402, first, the part position outputting unit 604 performs object detection inference with respect to the photo shot image output in S1002 and outputs all positions of the parts which can be inferred. Next, the target identification unit 605 identifies a target part by comparing the input spot within the photo shot image and the output of the object detection. When the target part is identified, the target identification unit 605 calculates the distance between the input spot and the position output in each of the object detection and identifies the part of the object at a closest distance from the input spot as the target part.

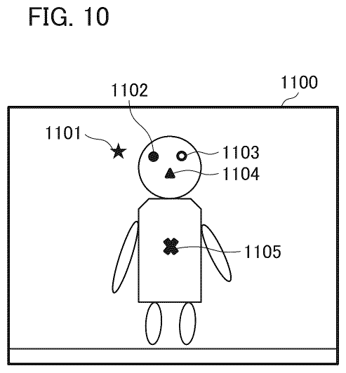

FIG. 10 is a view showing an example of an input spot within a photo shot image and output object detection according to Embodiment 3. An input spot with respect to a photo shot image 1100 is 1101. In addition, output results of the object detection are 1102 to 1105. As the detection results, 1102 is the position of “person's right eye”, 1103 is the position of “person's left eye”, 1104 is the position of “person's face”, and 1105 is the position of “person's body”. In this case, the “person's right eye” 1102 at a distance closest to the input spot 1101 is identified as the target part.

In S1004, the defocus range inference unit 402 infers (estimates) and outputs the defocus range of the target part identified by the target identification unit 605 with respect to the photo shot image output from the information acquisition unit 401. In this processing, it is assumed that the defocus range of “person's right eye” in the photo shot image identified by the target identification unit 605 as the target part is inferred by the defocus range outputting unit 606. The defocus range inference unit 402 outputs the photo shot image and the inferred defocus range to the importance level calculation unit 403.

In S1009, the importance level calculation unit 403 calculates the importance level R on the basis of the focus value V calculated in S1006 or S1007, the range width P calculated in S1008, and a target distance D calculated in S1003. Thereafter, the importance level calculation unit 403 outputs the calculated importance level R and the photo shot image to the saving unit 404. For example, calculation of the importance level R according to Embodiment 3 is performed as in the foregoing Expression (4), but it is not limited thereto.

In addition, after processing of S1000 to S1010 is performed with respect to the first photo shot image, the second and subsequent photo shot images may be subjected to the processing of S801 to S809 in FIG. 7 on the assumption that the mode for the same target part as that in the first photo shot image has been selected until S1000 is performed again.

Hereinabove, according to the image capturing device 10 of Embodiment 3, a user can automatically impart an importance level in a photo shot image at the time of photo shooting depending on the focus level at a desired point in a photo shot scene at the time of photo shooting.

### Embodiment 4

In Embodiment 4, when a user performs photo shooting, “a position to be used as a criterion for the focus level when an importance level is imparted to a photo shot image” of the live view screen is input during photo shooting. A method for imparting an importance level of a photo shot image will be described on the basis of the input positions, the focus levels of a plurality of parts of an object, and the distance.

Regarding the information acquisition unit 401, it performs processing similar to that in Embodiment 3, and therefore description thereof will be omitted. The defocus range inference unit 402 performs object detection of the position of a part of the object for which the defocus range is to be inferred and infers each defocus range of each of the identified parts.

As shown in FIG. 5D, the defocus range inference unit 402 according to Embodiment 4 has a part position outputting unit 607, a distance identification unit 608, and a defocus range outputting unit 609. The part position outputting unit 607 performs processing similar to that of the part position outputting unit 604 according to Embodiment 3, and therefore description thereof will be omitted.

The distance identification unit 608 calculates each of the distances in a two-dimensional plane of a captured image on the basis of the input spot within the photo shot image and the output of object detection. The distance identification unit 608 calculates each of the distances in a two-dimensional plane between the input spot within the photo shot image and the center position of each of the inferred parts in a manner similar to that in Embodiment 3. In other words, the distance identification unit 608 acquires distance information on each of the input position in the live view screen and the center positions of a plurality of parts (acquisition of a distance). The distance between the input spot and the center position of each of the inferred parts is denoted as a target distance.

The defocus range outputting unit 609 infers the defocus range of all the parts of the object output by the part position outputting unit 607 with respect to the photo shot image output from the information acquisition unit 401. The defocus range inference unit 402 outputs all the defocus ranges inferred by the defocus range outputting unit 609 and the target distance calculated by the distance identification unit 608 to the importance level calculation unit 403.

The importance level calculation unit 403 calculates the importance level of a photo shot image on the basis of each of the inferred defocus ranges, the positional relationship of the AF point, and/or the target distance. In addition, the importance level calculation unit 403 calculates the importance level by vectorizing each of the importance levels and taking the inner product of each of the vectors. The importance level calculation unit 403 outputs the calculated importance level and the photo shot image to the saving unit 404.

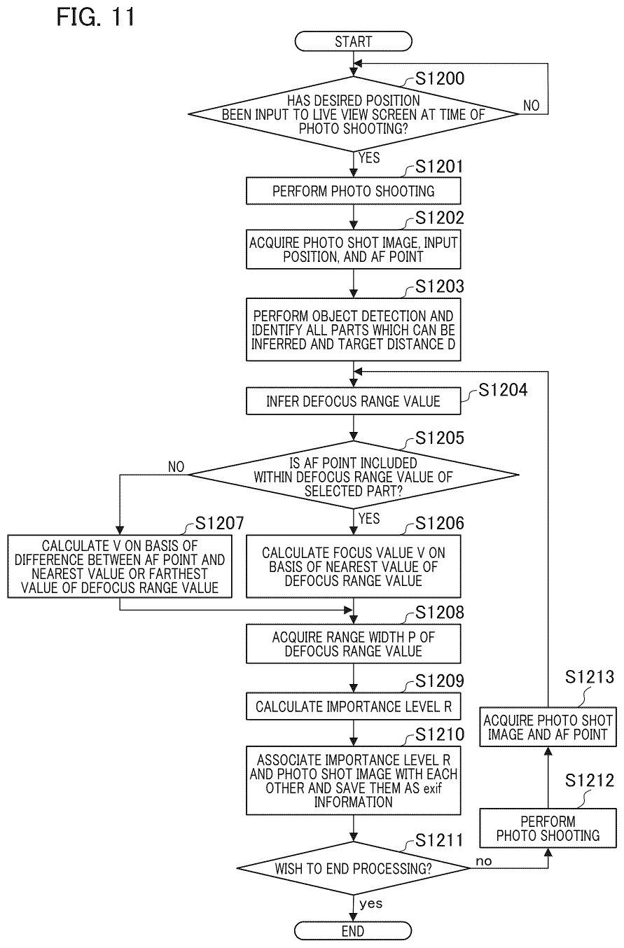

Next, a procedure of processing performed by the image capturing device 10 according to Embodiment 4 will be described with reference to FIG. 11. FIG. 11 is a flowchart of processing executed by the image capturing device 10 according to Embodiment 4. Each process of operation (processing) shown in the flowchart of FIG. 11 is realized by the system control unit 102 executing a program stored in the memory 104 or the like. In addition, in the following description, each process (step) will be denoted by adding “S” to the beginning, and notation of the process (step) will be omitted.

In Embodiment 4, the processing starts at the point of time when a user makes an input (if the system control unit 102 receives a signal indicating an input) with respect to the live view screen at the time of photo shooting in S1200, and the processing of S1200 to S1211 is performed with respect to the first photo shot image. Further, the second and subsequent photo shot images are subjected to the processing of S1204 to S1211 via the processing of S1212 and S1213.

First, processing for the first photo shot image (a photo shot image to be processed first) will be described. Here, S1200 to S1202 according to Embodiment 3 are similar to the processing of S1000 to S1002 in Embodiment 3, and therefore description thereof will be omitted. In addition, S1205 to S1208 are similar to the processing of S804 to S807 in Embodiment 1, and therefore description thereof will be omitted.

In S1203, the defocus range inference unit 402 performs object detection of all the positions of the parts of the object which can be inferred and outputs the defocus range. First, the part position outputting unit 607 performs object detection inference with respect to the photo shot image and outputs all positions of the parts which can be inferred. In this processing, it is assumed that the center position of each of “dog's right eye”, “dog's left eye”, “dog's face”, and “dog's body” has been output. Next, the distance identification unit 608 calculates the target distance D by comparing the input spot within the photo shot image and the output of the object detection.

In S1204, the defocus range inference unit 402 infers and outputs the defocus range of all the parts of the object inferred in S1203 with respect to the photo shot image output from the information acquisition unit 401. In this processing, it is assumed that the defocus ranges of the foregoing four parts (dog's right eye, dog's left eye, dog's face, and dog's body) that are the parts which can be inferred by the defocus range inference unit 402 are inferred by the defocus range outputting unit 609. The defocus range inference unit 402 outputs the photo shot image, the inferred defocus range, and the target distance D to the importance level calculation unit 403.

In S1209, the importance level calculation unit 403 calculates the part importance level R with respect to each of the parts (a plurality of parts) on the basis of the focus value V calculated in S1206 or S1207, the range width P calculated in S1208, and the target distance D calculated in S1203. Thereafter, the importance level calculation unit 403 outputs the calculated importance level R and the photo shot image to the saving unit 404. For example, calculation of the part importance level R is performed as in the following Expression (6), but it is not limited thereto.

$$[ Expression 6 ]$$

$$R = V / P / D \qquad ( 6 )$$

With respect to the importance level calculated by the foregoing Expression (4), the importance level of a part at a distance closer to the input spot is regarded as more important, and the part importance level R is calculated to be higher. The calculated part importance levels R are collectively retained as one vector.

The following is a criterion vector B. In the case of the present embodiment, when “dog's right eye”=right_eye, “dog's left eye”=left_eye, “dog's face”=face, and “dog's body”=body are set, the following Expression (7) is established.

$$[ Expression 7 ]$$

$$B = ( \begin{matrix}{R}_{right \_ eye} & {R}_{{left}_{eye}} & {R}_{face} & {R}_{body}\end{matrix} ) \qquad ( 7 )$$

In S1210, the saving unit 404 associates the photo shot image for which the defocus range has been inferred and the importance level calculated in S1209 with each other and saves in a storage medium such as an external storage device as Exif information. In the case of the processing of the first photo shot image, the importance level does not have to be imparted, or the maximum value of a composition importance level S at the point of time when the processing of FIG. 11 ends may be adopted as the importance level of the first photo shot image. The composition importance level S will be described below.

In S1211, the system control unit 102 judges whether to end the processing. If this processing is to be ended, the processing shown in FIG. 11 is ended. Meanwhile, if the processing is not ended, the processing proceeds to S1212. In this processing, the processing is performed with respect to the second and subsequent photo shot images, and therefore the processing proceeds to S1212.

Subsequently, processing of the second and subsequent photo shot images will be described. In S1212, the photo shooting unit 400 shoots an image. For example, the photo shooting unit 400 shoots an image in response to a user input. In S1213, the information acquisition unit 401 acquires the photo shot information which is information at the time of photo shooting in S1211. Specifically, an image (photo shot image) or a video image shot by the photo shot image acquisition unit 503 provided in the information acquisition unit 401 is acquired. Moreover, the AF point acquisition unit 504 provided in the information acquisition unit 401 acquires the AF point. The information acquisition unit 401 outputs the acquired information on the photo shot image to the defocus range inference unit 402. Moreover, the information acquisition unit 401 outputs the acquired information on the AF point to the importance level calculation unit 403. Thereafter, the processing proceeds to S1204.

In S1204, the defocus range inference unit 402 infers and outputs the defocus range of all the parts of the object inferred at the time of the processing of the first photo shot image with respect to the photo shot image. In the case of the present embodiment, the defocus range is output with respect to each of the foregoing four parts (dog's right eye, dog's left eye, dog's face, and dog's body). The photo shot image and the inferred defocus range are output to the importance level calculation unit 403.

Next, the processing of S1205 to S1208 is performed with respect to the output defocus range of each of the parts. In S1205 to S1208, processing similar to the processing for the first photo shot image is performed, and therefore description thereof will be omitted.

In S1209, first, the importance level calculation unit 403 calculates a part importance level R′ with respect to each of the parts on the basis of the focus value V calculated in S1206 or S1207 and the range width Pin S1208.

For example, calculation of the part importance level R′ is performed as in the foregoing Expression (4), but it is not limited thereto. The calculated part importance levels R′ are collectively retained as one vector (which will hereinafter be denoted as a composition vector B′). In the case of the present embodiment, the following Expression (8) is established.

$$[ Expression 8 ]$$

$${B}^{′} = ( \begin{matrix}{R}_{{right}_{eye}}^{′} & {R}_{{left}_{eye}}^{′} & {R}_{face}^{′} & {R}_{body}^{′}\end{matrix} ) \qquad ( 8 )$$

Next, the composition importance level S is calculated by the following Expression (9).

$$[ Expression 9 ]$$

$$S = B * {B}^{′} \qquad ( 9 )$$

Further, the importance level calculation unit 403 calculates the inner product of the criterion vector B retained at the time of the processing of the first photo shot image and the composition vector B′ and determines the composition importance level S. When the composition importance level S is determined, the similarity of the focus level of each of the parts in the second and subsequent photo shot images calculated and determined based on the focus level of each of the parts in the first photo shot image. In the case of a focus composition which is the same as the first photo shot image (for example, the right eye and the face are in focus but the body is not in focus, or the like), the composition importance level S is calculated to be higher. The importance level calculation unit 403 outputs the calculated composition importance level S and the photo shot image to the saving unit 404.

In S1210, the saving unit 404 associates the photo shot image for which the defocus range has been inferred and the composition importance level S calculated in S1209 with each other and saves them in a storage medium such as an external storage device as Exif information. Thereafter, the processing proceeds to S1211, and processing similar to that described above is performed.

Hereinabove, according to the image capturing device 10 of Embodiment 4, a user can automatically impart an importance level on the basis of the composition of a photo shot image based on the focus level at a desired point in a photo shot scene at the time of photo shooting.

The embodiments described above are merely representative examples, and various changes and modifications can be made for the foregoing embodiments when implementing the present invention.

In addition, the processing in FIGS. 7, 9, and 11 performed by the image capturing device 10 is an example, and the image capturing device 10 of the present embodiment may be subjected to change in the processing or details of the processing performed in accordance with user settings or the circumstances before the start of the processing. In other words, the image capturing device 10 does not necessarily have to perform all the processes (steps) described in the flowcharts shown in FIGS. 7, 9, and 11.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image capturing device comprising:
an image capturing unit;
an information acquisition unit that acquires photo shot information at the time of photo shooting by the image capturing unit;
a defocus range estimation unit that estimates a defocus range with respect to one or more parts of an object on the basis of the photo shot information at the time of photo shooting;
an importance level calculation unit that calculates an importance level of a photo shot image, in which the defocus range has been estimated, on the basis of the photo shot information at the time of photo shooting and the defocus range; and
a saving unit that saves the importance level and the photo shot image in association with each other.

2. The image capturing device according to claim 1,
wherein the information acquisition unit comprises:
a photo shot image acquisition unit that acquires the photo shot image, and
an AF point acquisition unit that acquires a focal position in a depth direction at the time of photo shooting by the image capturing unit.

3. The image capturing device according to claim 2,
wherein the importance level calculation unit calculates the importance level on the basis of a positional relationship between the defocus range and the focal position.

4. The image capturing device according to claim 1,
wherein the information acquisition unit comprises:
a mode information acquisition unit that acquires mode information which is information on a mode for setting a photo shooting subject of interest in a photo shot image selected during photo shooting.

5. The image capturing device according to claim 4,
wherein the defocus range estimation unit comprises:
a target identification unit that identifies a part of an object, of which the defocus range is to be output, from the mode information, and
a defocus range outputting unit that estimates and output a defocus range of the part.

6. The image capturing device according to claim 4,
wherein the defocus range estimation unit comprises:
a part identification unit that identifies one or more parts of an object, for which a priority level has been set and the defocus range is to be output, from the mode information, and
a defocus range outputting unit that estimates and output a defocus range for each part for which the priority level has been set.

7. The image capturing device according to claim 6,
wherein the importance level calculation unit calculates the importance level on the basis of a positional relationship between the defocus range and the focal position, and the priority level of each part.

8. The image capturing device according to claim 1,
wherein the information acquisition unit comprises:
a positional information acquisition unit that acquires information on a position in a live view screen input during photo shooting.

9. The image capturing device according to claim 1,
wherein the defocus range estimation unit comprises:
a part position estimation unit that estimates center positions of a plurality of parts in an object,
a target identification unit that identifies a part closest to the position in the input live view screen on the basis of distance information on each of the position in the input live view screen and the center positions of the plurality of parts, and
a defocus range outputting unit that estimates and output a defocus range of a part closest to the center position.

10. The image capturing device according to claim 9,
wherein the information acquisition unit comprises:
an AF point acquisition unit that acquires a focal position in a depth direction at the time of photo shooting by the image capturing unit, and
the importance level calculation unit calculates the importance level on the basis of a positional relationship between the defocus range and the focal position, and the distance information.

11. The image capturing device according to claim 1,
wherein the defocus range estimation unit comprises:
a part position estimation unit that estimates center positions of a plurality of parts in an object,
a distance acquisition unit that acquires distance information on each of the position in the input live view screen and the center positions of the plurality of parts, and
a defocus range outputting unit that estimates and output defocus ranges of the plurality of parts.

12. The image capturing device according to claim 11,
wherein the information acquisition unit comprises:
an AF point acquisition unit that acquires a focal position in a depth direction at the time of photo shooting by the image capturing unit, and
the importance level calculation unit calculates the importance level on the basis of a positional relationship between the defocus ranges of the plurality of parts and the focal position, or the distance information.

13. A non-transitory computer-readable storage medium that stores a computer program comprising instructions for executing following processes:
acquiring photo shot information at the time of photo shooting by an image capturing unit,
estimating a defocus range with respect to one or more parts of an object on the basis of the photo shot information at the time of photo shooting,
calculating an importance level of a photo shot image, in which the defocus range has been estimated, on the basis of the photo shot information at the time of photo shooting and the defocus range, and
saving the importance level and the photo shot image in association with each other.

14. An image capturing method comprises:
acquiring photo shot information at the time of photo shooting by an image capturing unit,
estimating a defocus range with respect to one or more parts of an object on the basis of the photo shot information at the time of photo shooting,
calculating an importance level of a photo shot image, in which the defocus range has been estimated, on the basis of the photo shot information at the time of photo shooting and the defocus range, and
saving the importance level and the photo shot image in association with each other.
